(19) United States
(12) Patent Application Publication
(10) Pub. No.: US 2025/0347307 A1
(43) Pub. Date: Nov. 13, 2025

(54) Anchoring Fastener

(71) Applicant: Robert Bosch GmbH, Stuttgart (DE)

(72) Inventors: Daniel White, Bettendorf, IA (US); Eric Siegel, Arlington Heights, IL (US); Jeremy Rubens, Palatine, IL (US); Walter Bernardi, Highland Park, IL (US)

(21) Appl. No.: 19/195,976

(22) Filed: May 1, 2025

Related U.S. Application Data
(60) Provisional application No. 63/644,134, filed on May 8, 2024.
(60) Provisional application No. 63/644,137, filed on May 8, 2024.

(51) Int. Cl. F16B 15/04; F16B 15/00; F16B 15/08

(52) U.S. Cl. CPC F16B 15/04; F16B 15/08; F16B 15/0015

(57) ABSTRACT

A fastener includes an elongated body having a striking end, a middle region, and a tip end region. The striking end and the middle region define a longitudinal axis. The striking end has a first cross-section that is substantially equivalent to a second cross-section of the middle region, and the tip end region includes a tip that is offset relative to the longitudinal axis.

### CROSS-REFERENCE TO RELATED APPLICATION

This application claims priority to U.S. Provisional Application Ser. No. 63/644,134 entitled “Anchoring Fastener,” filed on May 8, 2024, and to U.S. Provisional Application Ser. No. 63/644,137 entitled “Anchoring Tool,” filed on May 8, 2024, the disclosures of both of which are incorporated herein by reference in their entirety.

This application is related to U.S. patent application Ser. No. ______ (attorney docket no. 1576-3025) entitled “Anchoring Tool” filed on same date herewith, the contents of which are incorporated herein by reference in their entirety.

### FIELD

This disclosure relates generally to fasteners, and, more particularly, fasteners driven into a workpiece by a fastening tool having a striker.

### BACKGROUND

In trim carpentry, to install trim and molding, a piece of trim is typically attached to drywall or to another piece of wood by driving a nail through the trim piece using a nailing tool, also referred to in the art as a nailer. The friction between the nail and the drywall retains the nail in the drywall, while the nail head affixes the trim piece to the drywall. However, the frictional force retaining the nail in the drywall is prone to failure either through failure of the drywall itself, or weakening of the frictional connection between the nail and the drywall over time.

One conventional solution to the aforementioned problem is to drive the nail entirely through the drywall and into the wood framing located behind the drywall. However, this solution requires a relatively long, and therefore large, nail to pass through the trim and the drywall with enough of the nail driven into the wood to hold the trim in place. Further, driving a nail entirely through the trim and the drywall requires a relatively large amount of energy to be imparted on the nail via the nailing tool, which necessitates a more powerful nailer, and in some instances, a larger and more expensive nail. Moreover, the periodic expansion and contraction of the drywall associated with temperature changes still loosens the frictional connection between the nail and the framing wood over time, resulting in eventual failure of the connection. What is needed, therefore, is a fastener connection that does not rely on friction to retain the fastener in the materials.

In addition, because the conventional nail requires the nail head to maintain the position of the trim piece, insertion of the nail leaves a relatively large hole in the trim piece. This hole can be an eyesore. Alternatively, the hole may be patched for aesthetic purposes, but this requires significant additional labor to disguise the nail head. Thus, it would be beneficial if the fastener did not have an enlarged nail head.

### SUMMARY

In some aspects, the disclosure relates to a fastener including: an elongated body having a striking end, a middle region, and a tip end region. The striking end and the middle region define a longitudinal axis. The striking end has a first cross-section that is substantially equivalent to a second cross-section of the middle region, and the tip end region includes a tip that is offset relative to the longitudinal axis.

In some aspects, the tip end region includes a first angled surface formed on a first lateral side of the tip end region, the first angled surface defining the tip and being angled transversely to the longitudinal axis.

The tip end region may include a second angled surface formed on a second lateral side of the tip end region that is opposite the first lateral side. The second angled surface defines the tip, the tip being closer to the second lateral side than the first lateral side.

In some aspects, the first angled surface defines an angle of between 4 and 60 degrees relative to the longitudinal axis. In other embodiments, the angle may be between 4 and 16 degrees, or between 16 and 60 degrees.

In another embodiment, the techniques described herein relate to a fastener, wherein the second end includes a bend having a deflection that is spaced apart from the tip.

In some aspects, the techniques described herein relate to a set of fasteners including: a first fastener including a first elongated body having a first striking end, a first middle region, and a first tip end, the first striking end and the first middle region defining a first longitudinal axis, the first tip end having a first tip that is offset in a first direction relative to the first longitudinal axis; and a second fastener adjacent to the first fastener, the second fastener including a second elongated body having a second striking end, a second middle region, and a second tip end, the second striking end and the second middle region defining a second longitudinal axis, the second tip end having a second tip that is offset in a second direction relative to the first longitudinal axis, the second direction being different than the first direction.

In some aspects, the first striking end has a cross-section that is substantially equivalent to a cross-section of the first middle region, and the second striking end has a cross-section that is substantially equivalent to a cross-section of the second middle region.

In one embodiment, the first direction is substantially opposite to the second direction.

In certain embodiments, the set of fasteners includes a dual strip of fasteners, a first strip of the dual strip including the first fastener and a second strip of the dual strip including the second fastener.

In some aspects, the first strip includes a third fastener adjacent to the first fastener and having a third tip that is offset in a third direction, and the second strip includes a fourth fastener adjacent to the second fastener and having a fourth tip that offset in a fourth direction.

The first and fourth directions may be substantially opposite to one another, and the second and third directions may be substantially opposite to one another.

In some aspects, the first fastener and the second fastener are adjacent to one another in a single strip of fasteners.

The set of fasteners may, in some embodiments, include a connector that connects the first fastener and the second fastener to one another.

In some aspects, the techniques described herein relate to a fastener including: an elongated body having a striking end, a middle region, and a tip end region defining a tip, the striking end and the middle region defining a longitudinal axis, wherein the tip end region includes a deflection at which the elongated body is deflected out of the longitudinal axis.

The deflection may have a point of maximum deflection that is spaced apart from the tip.

In other embodiments, the deflection has a point of maximum deflection at the tip.

### BRIEF DESCRIPTION OF THE DRAWINGS

FIG. 1 is a side view of a first embodiment of a fastener according to the disclosure.

FIG. 2 is a side cross-sectional view of the fastener of FIG. 1 after being driven into two workpieces.

FIG. 3 is a perspective view of a connected pair of the fasteners of FIG. 1.

FIG. 4 is a side cross-sectional view of the connected pair of fasteners of FIG. 3 after being driven into two workpieces.

FIG. 5 is a cross-sectional view through a dual strip of the fasteners of FIG. 1.

FIG. 5A is a cross-sectional view through a strip of the fasteners of FIG. 1.

FIG. 6 is a cross-sectional view through a strip of the fasteners of FIG. 1.

FIG. 7 is a cross-sectional view through a strip of the fasteners of FIG. 1.

FIG. 8 is a side view of the tip region of a fastener according to the disclosure.

FIG. 9 is a side schematic view of a bent fastener according to the disclosure.

FIG. 10 is a side schematic view of another bent fastener according to the disclosure.

FIG. 11 is a side schematic view of a notched fastener according to the disclosure.

FIG. 12 is a side schematic view of a staple-type fastener according to the disclosure.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

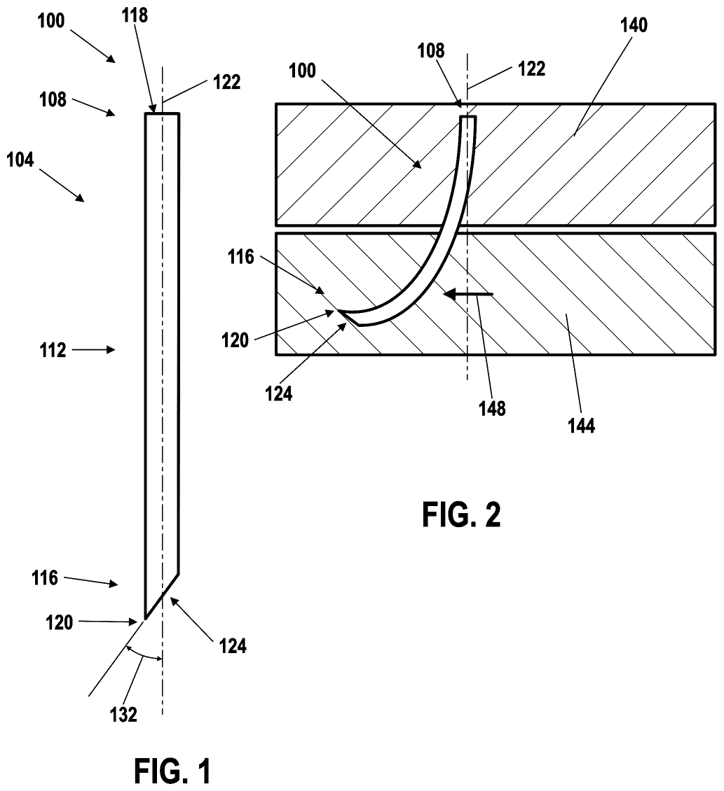

FIG. 1 depicts a fastener 100 for connecting two or more structures. The fastener includes an elongated body 104 having a first end configured as a striking end 108, a middle region 112, and a second end configured as a tip end region 116. The striking end 108 is formed without a nail head such that the striking end 108 has a substantially equivalent cross-section (i.e. substantially equal cross-sectional size and shape) to the middle region 112. More specifically, in some embodiments, the cross-sectional area of the striking end 108, and more particularly the cross-sectional area of the striking surface 118, may be within 10% of the cross-sectional area of the middle region 112. In another embodiment, the cross-sectional area of the striking end 108, and more particularly the cross-sectional area of the striking surface 118, may be within 5% of the cross-sectional area of the middle region 112. The striking end 108 and middle region 112 may have any desired cross-sectional shape such as, for example, a circle, rectangle, square, oval, a narrow rectangle (i.e. a strip), etc. The fastener 100 may be formed of any desired material such as, for example, steel, aluminum, ceramic, plastic, and the like.

The tip end region 116 defines an asymmetric tip 120 in which the tip 120 is offset relative to a longitudinal axis 122 defined by the striking end 108 and middle region 112 of the fastener 100. In the illustrated embodiment, the asymmetric tip 120 is formed entirely or primarily on only one side so as to form a tip 120 that is arranged on one lateral side of the tip end region 116. The tip 120 may be, for example, formed to a point or an edge that is arranged on an outer lateral third of the tip end region 116. The asymmetrical configuration of the tip end region 116 results in an angled surface 124 being formed on one lateral side of the tip end region 116. In particular, the angled surface 124 is angled transversely to the longitudinal axis 122.

FIG. 2 illustrates the fastener 100 after being driven into two workpieces 140, 144, though the reader should appreciate that the fastener 100 may be used to connect more than two workpieces. The fastener 100 may be used, for example, in a conventional nailing tool, such as a brad nailer, a framing nailer, a finish nailer, a fence nailer, a concrete nailer, a drywall nailer, a siding nailer, a steel joist nailer, a roofing nailer, a stapler, and the like. Alternatively, the fastener 100 may be driven in manually using a hammer. The fastener is designed such that the striking end 108 of the fastener 100 to drive the fastener 100 into a workpiece 140, for example a wood trim piece, to fasten the workpiece 140 to another workpiece 144, for example drywall. As the tip end region 116 of the fastener 100 is driven into the surface of the workpiece 140, the angled surface 124 of the tip end region 116 deflects a portion of the reaction force acting on the tip end region 116 in the lateral direction 148 toward the tip 120. As a result, the elongated body 104 of the fastener 100 curves as it is driven into the workpieces 140, 144.

In particular, the fastener 100 curves in a parabolic manner progressively more from the longitudinal axis 122; in other words, the tip end region 116 forms a greater angle from the longitudinal axis 122 than the middle region 112, which forms a greater angle from the driving axis than the striking end 108. Thus, once driven into the workpieces 140, 144, the fastener 100 is curved into a hook shape with the portion in the workpiece 144 at a greater angle from the longitudinal axis 122 than the portion of the fastener in the top workpiece 140.

Because the fastener 100 is curved into a hook shape, the fastener 100 cannot be removed from either workpiece 140, 144 without applying a shear force to bend the fastener in the direction opposite to the hook. As a result, the fastener 100 can only be removed with application of sufficient force to mechanically deform the fastener 100. Thus, the fastener 100 maintains the mechanical connection between the workpieces 140, 144 with reduced reliance on the frictional force between the fastener and the workpieces 140, 144, and without the need for an enlarged head at the striking end 108.

The fastener 100 may be designed to select the degree of curvature of the fastener based on the material of the fastener 100 and the material of the workpieces in which the fastener is intended to be used. In particular, the angle 132 formed by the angled surface 124 relative to the longitudinal axis 122, may be selected to change the degree of curvature of the fastener 100 in the workpieces 140, 144. For instance, a relatively shallow angle 132 may be used to reduce the curvature and, in some instances, drive the fastener 100 straight into the workpiece at an angle, while a relatively large angle 132 may be used to increase the curvature. The angle 132 may be, for example, between 4 and 60 degrees. In some embodiments, the angle 132 may be between 5 and 30 degrees. In another embodiment, the angle 132 may be between 5 and 16 degrees. In yet another embodiment, the angle 132 may be approximately 10 degrees. Further embodiments include an angled surface 124 that may be angled from 16 to 60 degrees.

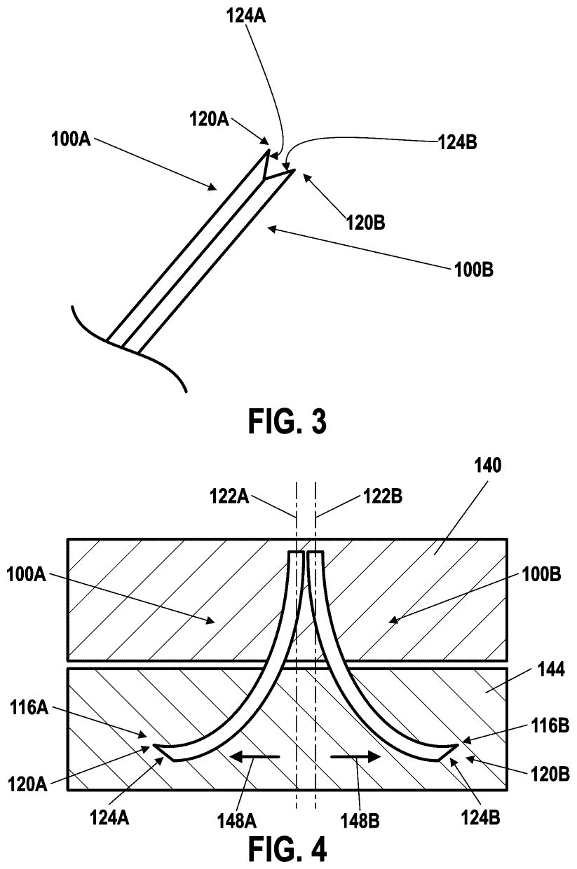

FIG. 3 illustrates an embodiment in which two round fasteners 100A, 100B are connected to one another and are configured to be driven into the workpieces 140, 144 simultaneously or nearly simultaneously. In particular, the two fasteners 100A, B may be releasably affixed to one another as part of a strip of fasteners designed to be inserted into the magazine of a nailer. The two fasteners 100A, B are oriented differently relative to one another such that, upon being driving into the workpieces 140, 144, the two fasteners 100A, B bend in different directions. In the embodiment illustrated in FIG. 3, the two fasteners 100A, B are configured such that the tips 120A, 120B of the two fasteners 100A, B are on the lateral side of the respective fastener 100A, B substantially opposite the other fastener 100B, A. In other embodiments, the fasteners 100A, B may not be opposite to the other, but instead may form an angle of 90 degrees offset, 135 degrees offset, or be arranged in a range of between 90 and 270 degrees offset, between 135 and 225 degrees offset, between 150 and 210 degrees offset, between 171 and 190 degrees offset, etc.

As seen in FIG. 4, the respective flat surfaces 124A, B of the tip regions 116A, B cause the reaction force acting on the fasteners 100A, B to be exerted in opposite directions 148A, B. As a result, the fastener 100A curves away from its longitudinal axis 122A in a first direction 148A, while the fastener 100B curves away from its longitudinal axis 122B in a second direction 148B that is opposite to the first direction 148A. The two fasteners 100A, B therefore form hook-shaped curves in opposite directions to one another. Thus, the two fasteners 100A, B must be deformed in opposite directions to move the outer workpiece 140 away from the inner workpiece 144. This configuration forms an anchor that produces a particularly strong connection between the two workpieces 140, 144.

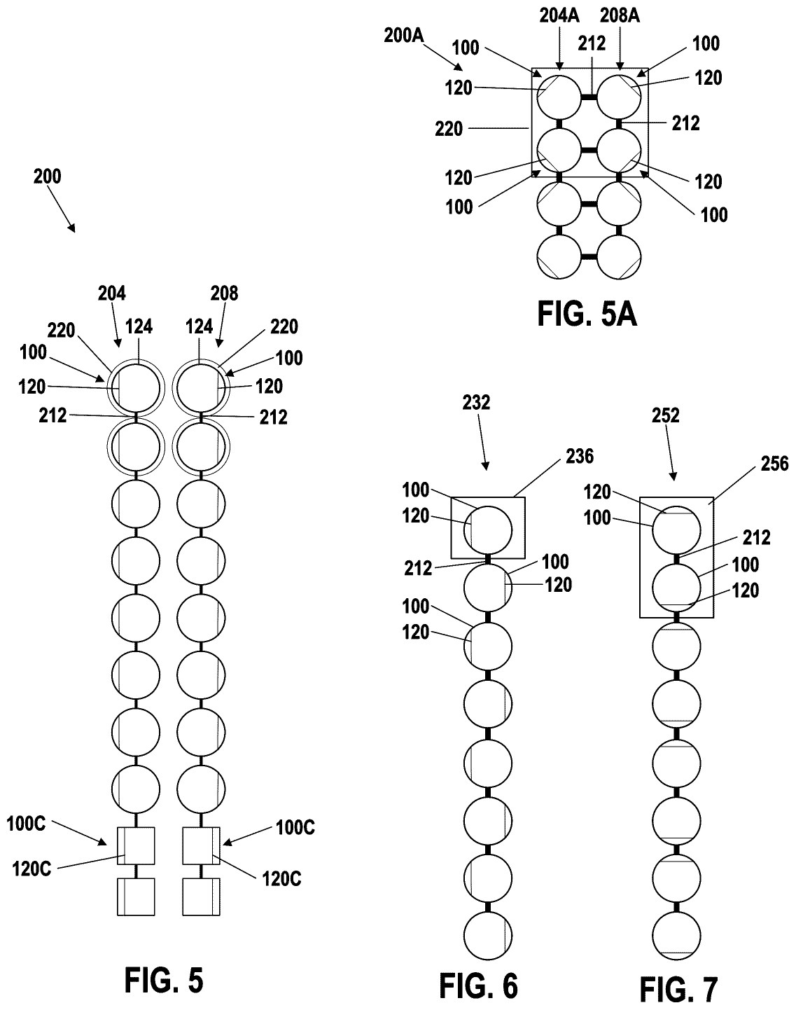

FIG. 5 illustrates a set of fasteners 100 formed as a dual strip 200 of fasteners 100 for use in a nailer. The dual strip 200 includes a first strip 204 of fasteners 100 in which the tip 120 is offset to one side, and a second strip 208 of fasteners 100 in which the tip 120 is offset to the opposite side. In particular, as in the embodiment discussed above with regard to FIG. 3, each strip 204, 208 is configured such that the tip 120 is offset in a direction substantially opposite the other strip 208, 204, for example offset by an angle of between 170 and 190 degrees.

The fasteners 100 of each strip 204, 208 are retained together by a connector 212, for example glue, paper, wire, tape, or the like. In addition, in some embodiments, the two strips 204, 208 may be connected to each other by a connector (e.g. FIG. 5A). The two strips 204, 208 are inserted into a nailer such that the striker or strikers 220 of the nailer drives the top one or two fasteners 100 of each strip 204, 208 into the workpieces simultaneously or, in other words, drives two or four fasteners 100 with each firing. Since the fasteners 100 are configured such that the tips 120 are oriented on the opposite side of the adjacent strip 204, 208, the dual strip 200 configuration produces the outwardly curved connection illustrated in FIG. 4 with each actuation of the nailer.

FIG. 5A illustrates another example of a set of fasteners 100 formed as a dual strip 200A of fasteners 100 having a diagonal configuration. Specifically, the top two fasteners 100 of each strip 204A, 208A form four fasteners 100 having tips 120 oriented in four different and substantially perpendicular directions. In other words, tips 120 of the top fastener 100 of first strip 204A and the second fastener 100 from the second strip 208A are offset in opposite directions from one another, while tips 120 of the top fastener 100 of the second strip 208A and the second fastener 100 of the first strip 204A are offset in opposite directions from one another. Further, in the embodiment of FIG. 5A, each fastener 100 of the first strip 204A is connected to the adjacent fastener 100 of the second strip 208A. The dual strip 200A of FIG. 5A may be used with a striker 220 configured to actuate four fasteners 100, namely the top two fasteners 100 of each strip 204A, 208A, to produce a double anchor connection similar to two of the anchored connections shown in FIG. 4 oriented perpendicular to one another or, in other words, forming an X-shape when viewed from the top.

Additionally, FIG. 5 depicts some of the fasteners 100 as round fasteners 100, and some of the fasteners as square fasteners 100C. Similarly to the round fasteners, the square fasteners 100C have a tip 120C that is arranged asymmetrically offset on the side opposite the other strip 204, 208 of fasteners 100C. The reader should appreciate that the strips 204, 208 may be configured with all round fasteners 100, all square fasteners 100C, an alternating pattern of round and square fasteners 100, 100C, any other desired pattern of round and square fasteners, or fasteners of another cross-sectional shape such as oval, triangular, etc.

FIG. 6 depicts another set of fasteners 100 formed as a strip 232 of fasteners 100 configured to be used in a nailer with a striker 236 that drives a single fastener, or in a nailer that simultaneously drives the first two fasteners of the strip 232. Each fastener 100 in the strip 232 is arranged with the tip 120 offset in a different direction from the adjacent fasteners 100. In the illustrated embodiment, the fasteners 100 alternate such that the fasteners 100 are offset alternating across the longitudinal direction defined by the sequence of fasteners 100 of the strip 232 or, in other words, one fastener 100 is arranged with the tip 120 offset to the left in the view of FIG. 6, while the next is arranged with the tip 120 offset to the right, and so on. The strip 232 of FIG. 6 is usable in a conventional nailer that fires one fastener in each actuation such that actuating the nailer twice in near proximity essentially produces the anchored connection illustrated in FIG. 4. Alternatively, the strip 232 may be used in a nailer configured such that the striker drives both of the first two nails to essentially produce the anchored connection illustrated in FIG. 4.

FIG. 7 illustrates another configuration of a set of fasteners 100 formed as a strip 252 of fasteners 100. Again, the strip 252 may be used in a nailer with a striker that drives a single fastener 100 with each actuation of the nailer (i.e. the striker 236 of FIG. 6) or with a nailer having a striker 256 that drives both of the first two fasteners 100 with each actuation of the nailer. In the strip 252 of FIG. 7, the fasteners 100 are configured such that the offset of the tip 120 alternates along the axis of the strip, i.e. to the top or bottom of the fastener 100 in the view of FIG. 7. More specifically, the first fastener 100 is offset in the direction opposite of the second fastener 100, and the second fastener 100 is offset in the direction opposite of the first fastener and toward the third fastener, and so on. Similarly to the strip of FIG. 6, using the strip 252 in a nailer that drives a single fastener in each actuation to drive two fasteners 100 near to one another produces essentially the same anchor configuration depicted in FIG. 4. Using the strip 252 in a nailer with a striker 256 that drives two fasteners 100 simultaneously results in the same anchor configuration depicted in FIG. 4.

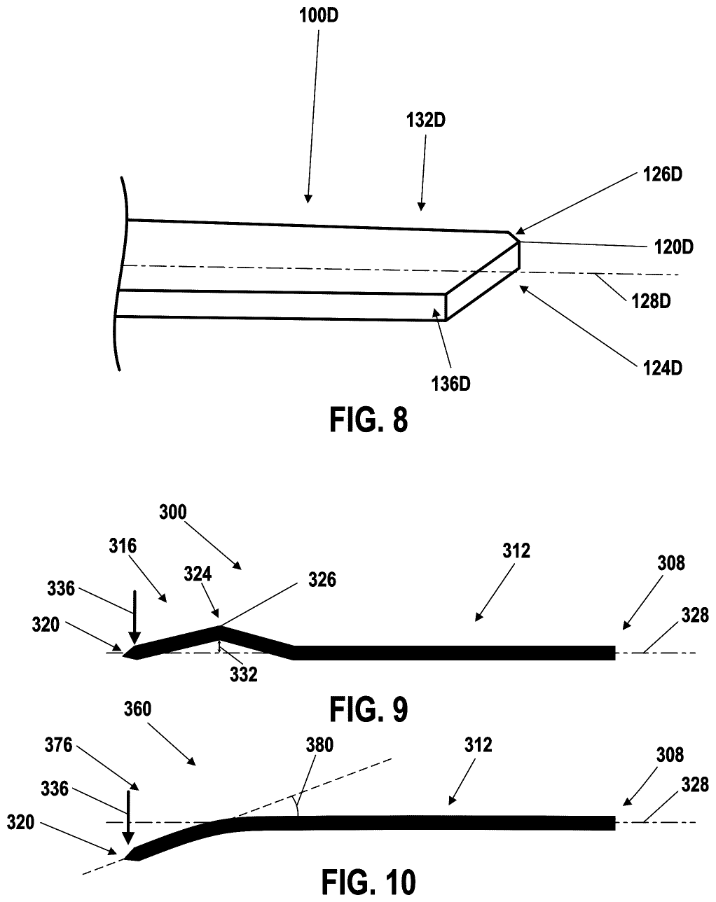

FIG. 8 illustrates a side view of a fastener 100D similar to the fasteners described above. The view of FIG. 8 better illustrates the tip 120D of the fastener being arranged asymmetrical to, but not fully at the lateral end of the fastener 100D. In particular, as seen in FIG. 8, the tip end region 116D has a larger surface 124D and a smaller surface 126D forming the tip 120D as an offset edge of the fastener 100D. The tip 120D is arranged closer to a first lateral side 132D than to a second, opposite lateral side 136D of the tip end region. In particular, the lateral distance defined perpendicular to the longitudinal axis 128D from the tip 120D to the second lateral side 136D may be between approximately 3 and 8 times greater than the lateral distance from the tip 120D to the first lateral side 132D. In another embodiment, the lateral distance from the tip 120D to the second lateral side 136D may be between approximately 4 and 6 times greater than the lateral distance from the tip 120D to the first lateral side 132D.

FIG. 9 illustrates a side view of another fastener 300 configured to deform upon being driven into workpieces to produce a similar connection as shown in FIG. 2. The fastener 300 has a striking end 308, a middle region 312, and a tip end region 316. The tip region 316 of the fastener 300 is configured with a conventional tip 320, for example a bi-segment or four quadrant sharpening. The tip region 316 is further configured with a deformation or bend 324 that is, in some embodiments, configured such that the tip 320 is offset from the longitudinal axis 328 of the fastener 300. In particular, the point of maximum deflection 326 is spaced apart from the tip 320 along the longitudinal axis 328. In particular, the distance between the tip 320 and the point of maximum deflection 326 may be between approximately 15% and 25% of the overall longitudinal length of the fastener 300.

The bend 324 may have, for example, a maximum deflection 332 from the longitudinal axis 328 of between approximately 25% and approximately 200% of the diameter or width perpendicular to the longitudinal axis 328 of the fastener 300. In another embodiment, the maximum deflection 332 may be between approximately 50% and 100% of the diameter or width. The maximum deflection 332 may be selected in various configurations to provide the desired amount of curvature to the driven nail based on the materials to be connected by the fastener. In addition, the longitudinal distance from the maximum deflection 332 to the tip 320 may be adjusted based on the desired amount of curvature.

When driven into the workpieces, the deflection 332 causes the tip 320 of the fastener to engage the workpieces at an angle relative to the longitudinal axis 328. As a result, the surface of the tip 320 on the side of the deflection 332 engages at a greater angle of attack to the workpiece relative to the opposite surface of the tip 320. Thus, the driving of the fastener 300 causes a reaction force 336 from the workpiece directed opposite the direction of the deflection 332, thereby causing the fastener 300 to bend in a similar manner as the fastener 100 described above. Consequently, the fastener 300 forms a curved anchor in a similar manner as in the embodiments described above.

The fastener 360 of FIG. 10 is similar to the fastener 300 of FIG. 9, except that the point of maximum deflection of the tip end region 376 of the fastener 360 is collocated with the tip 320. In other words, the tip end region 376 is bent out of the longitudinal axis 328 such that the tip 320 is angled relative to the longitudinal axis 328. In some embodiments, the tip 320 is bent such that the tip 320 forms an angle 380 of between approximately 2 degrees and 25 degrees relative to the longitudinal axis 328. In one particular embodiment, the angle 380 may be between approximately 5 and 20 degrees, and in another embodiment, between approximately 10 and 15 degrees. The angle 380 may be tuned in various configurations to provide the desired amount of curvature to the driven nail based on the materials to be connected by the fastener. In addition, the longitudinal distance from the bend to the tip 320 may be adjusted based on the desired amount of curvature of the fastener 360 in the workpiece.

The fastener 360 functions in a similar manner as the fastener 300. Upon being driven into the workpieces, the surface of the tip 320 opposite the bend (i.e. the side on the top in the view of FIG. 10) engages at a greater angle of attack than the surface of the tip 320 on the side of the bend (on the bottom in the view of FIG. 10). As a result, the fastener 360 is bent further as it is driven into the workpieces, forming the hook shape illustrated in FIG. 2.

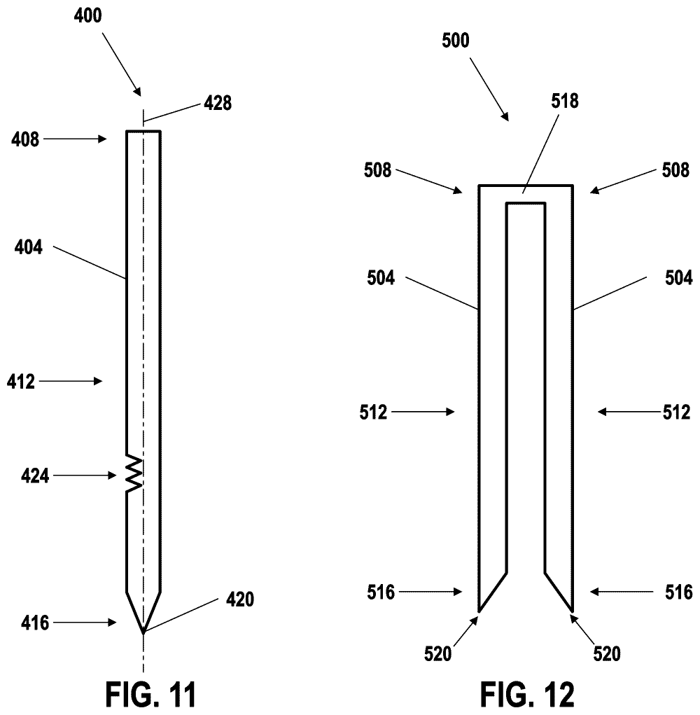

FIG. 11 illustrates another fastener 400 that has one or more notches 424 defined into the main body 404 in either the middle region 412 or a portion of the tip end region 416 that is spaced apart from the tip 420. The geometry of the notches 424, for example the length, depth, quantity, and shape of the notches 424, can be selected depending on the desired amount of curvature of the fastener 400 when driven into the workpieces.

In one embodiment, the fastener 400 includes a plurality of notches 424 arranged adjacent to one another, in particular directly adjacent to one another. The notches 424 each have a “V” shape when viewed in cross-section, and have a depth of approximately 40% to 60% of the width of the fastener 400 measured perpendicular to the axis 428. In the illustrated embodiment, the plurality of notches 424 includes three notches, with the V-shape forming an angle of approximately 40 to approximately 50 degrees or, in other words, each leg of the V-shape forms an angle of approximately 20 to approximately 25 degrees relative to the longitudinal axis 428.

The fastener of FIG. 11 is driven in a similar manner as the fasteners described above. The striker of the nailing tool strikes the striking end 408 along the longitudinal axis 428, causing the fastener 400 to be driven into the workpieces. The reaction force acting along the longitudinal axis 428 results in compression of the fastener body 404, and, because of the lack of material in the notches 424, the notched side has a reduced resistance to the compression forces. As a result, the notched side of the fastener 400 deforms to a greater extent than the opposite side, thereby resulting in a bend of the fastener 400 in the direction toward the notches 424. The notches 424 narrow during this deflection, similar to an accordion, while the material directly opposite the notches 424, and particularly on the opposite surface of the notches 424, elongates. The presence of a plurality of notches 424 allows for the elongation to be spread out over a greater length of the fastener 400 such that the elongation does not cause the fastener 400 to fracture. Once the deformation has begun, the angle of attack of the tip on the side opposite the notches increases, resulting in additional force acting in the direction of the notches. As a result, the deformation continues to increase as the fastener 400 drives into the workpieces, thus causing the fastener 400 to form the curved hook shape shown in FIG. 2.

FIG. 12 illustrates a fastener 500 configured as a staple having two elongated bodies 504 with respective striking ends 508, middle regions 512, and tip regions 516. The two bodies 504 are connected at their respective striking ends 508 by a connector 518. The tips 520 of each of the two elongated bodies 504 are formed asymmetrically in a manner similar to the fasteners described above, and are in particular configured such that the tips 520 are on the side of the respective bodies 504 opposite the other body 504. As a result, upon being driven into the workpieces, the two bodies 504 of the fastener 500 curve outwardly in opposite directions, thereby forming a shape similar to the anchor depicted in FIG. 4.

In other embodiments, the fastener may be bent in two different axes. For example, the fastener may be bent in a corkscrew shape with bend in two perpendicular planes. In such an embodiment, the fastener drives into the workpieces in a corkscrewing trajectory, which can only be disengaged from the workpieces with application of sufficient shear force in multiple planes to overcome the twisting of the fastener. Such a fastener may be configured in a strip shape, such that the fastener has a cross-sectional rectangular shape in which one dimension is substantially larger than the other dimension.

The fasteners described herein may have an enlarged head like a nail. However, the anchoring connection produced by the disclosed fasteners provides a secure connection between two workpieces without the need for such an enlarged head on the fastener. As a result, when attaching trim or fastening ornamental or aesthetic features, the hole left from the pin fastener is small and may, in some instances, be sufficiently small that little or no subsequent treatment, such as filling or painting, is required. The disclosed fasteners therefore enable trim carpentry to be performed faster and with less labor than conventional tools, while providing a connection between the materials that is as strong or stronger than using a conventional nail with an enlarged head.

The reader should appreciate that the fasteners disclosed herein are not limited to use in hand-held power tools. For instance, on a larger scale, the fasteners disclosed herein may be used with a pile driver to provide a stable and secure building support. Alternatively, on a smaller scale, the fasteners may be used in micromechanical systems to fasten two or more components together. Additionally, the disclosed fasteners may be used with manufacturing equipment such as, for example, industrial robots, and the like.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

1. A fastener comprising:
an elongated body having a striking end, a middle region, and a tip end region, the striking end and the middle region defining a longitudinal axis,
wherein the striking end has a first cross-section that is substantially equivalent to a second cross-section of the middle region, and
wherein the tip end region comprises a tip that is offset relative to the longitudinal axis.

2. The fastener of claim 1, wherein the tip end region includes a first angled surface formed on a first lateral side of the tip end region, the first angled surface defining the tip and being angled transversely to the longitudinal axis.

3. The fastener of claim 2, wherein the tip end region includes a second angled surface formed on a second lateral side of the tip end region that is opposite the first lateral side, the second angled surface defining the tip, the tip being closer to the second lateral side than the first lateral side.

4. The fastener of claim 2, wherein the first angled surface defines an angle of between 4 and 60 degrees relative to the longitudinal axis.

5. The fastener of claim 4, wherein the angle is between 4 and 16 degrees relative to the longitudinal axis.

6. The fastener of claim 4, wherein the angle is between 16 and 60 degrees relative to the longitudinal axis.

7. The fastener of claim 1, wherein the second end includes a bend having a deflection that is spaced apart from the tip.

8. A set of fasteners comprising:
a first fastener comprising a first elongated body having a first striking end, a first middle region, and a first tip end, the first striking end and the first middle region defining a first longitudinal axis, the first tip end having a first tip that is offset in a first direction relative to the first longitudinal axis; and
a second fastener adjacent to the first fastener, the second fastener comprising a second elongated body having a second striking end, a second middle region, and a second tip end, the second striking end and the second middle region defining a second longitudinal axis, the second tip end having a second tip that is offset in a second direction relative to the first longitudinal axis, the second direction being different than the first direction.

9. The set of fasteners of claim 8, wherein the first striking end has a cross-section that is substantially equivalent to a cross-section of the first middle region, and the second striking end has a cross-section that is substantially equivalent to a cross-section of the second middle region.

10. The set of fasteners of claim 9, wherein the first direction is substantially opposite to the second direction.

11. The set of fasteners of claim 9, wherein the set of fasteners includes a dual strip of fasteners, a first strip of the dual strip including the first fastener and a second strip of the dual strip including the second fastener.

12. The set of fasteners of claim 11, wherein:
the first strip includes a third fastener adjacent to the first fastener and having a third tip that is offset in a third direction, and
the second strip includes a fourth fastener adjacent to the second fastener and having a fourth tip that offset in a fourth direction.

13. The set of fasteners of claim 12, wherein:
the first and fourth directions are substantially opposite to one another, and
the second and third directions are substantially opposite to one another.

14. The set of fasteners of claim 9, wherein the first fastener and the second fastener are adjacent to one another in a single strip of fasteners.

15. The set of fasteners of claim 9, further comprising a connector that connects the first fastener and the second fastener to one another.

16. A fastener comprising:
an elongated body having a striking end, a middle region, and a tip end region defining a tip, the striking end and the middle region defining a longitudinal axis,
wherein the tip end region includes a deflection at which the elongated body is deflected out of the longitudinal axis.

17. The fastener of claim 16, wherein the deflection has a point of maximum deflection that is spaced apart from the tip.

18. The fastener of claim 16, wherein the deflection has a point of maximum deflection at the tip.
